(19) United States
(12) Patent Application Publication
(10) Pub. No.: US 2022/0383289 A1
(43) Pub. Date: Dec. 1, 2022

(54) System and method to facilitate peer to peer transactions by establishing trust network between the users

(71) Applicant: Pankaj Aggarwal, Ashland, MA (US)

(72) Inventor: Pankaj Aggarwal, Ashland, MA (US)

(21) Appl. No.: 17/334,826

(22) Filed: May 31, 2021

(51) Int. Cl. G06Q 20/22; G06Q 20/40; G06Q 20/38

(52) U.S. Cl. CPC G06Q 20/223; G06Q 20/4014; G06Q 20/3821

(57) ABSTRACT

Systems and methods are disclosed herein for computer-aided method for developing, customizing, and deploying a platform where people can provide service to other users based on a trust among multiple individuals. This is especially useful among ecommerce applications where users can initiate and complete an ecommerce transaction with an individual not directly trusted.

### BACKGROUND

### Field of the Invention

The present invention relates to a platform for establishing trust between users within a virtual or physical avenue and to allow for interaction between these users and more particularly relates to provision of likeness and trust scale for expressing their true opinion and proving services.

### Description of the Related Art

For the peer to peer service industry (example: Uber, Lyft etc), one major problem is trust. How does one know that the person providing service can be trusted? Current solution is to have a rating and reviews system. Users who are service providers on completion of the service will receive ratings, generally from the scale of 1 to 5. This rating will be aggregated with ratings received by this user (service provider) over time and these ratings will be displayed as a quality metric of this user. Service providers will also receive a written review from the users as a more contextual representation of the services rendered. Reviews and ratings together constitute one way of representing service providers quality. This system, however, provides no inherent security. Users only way of knowing more about the service provider is through the company facilitating the service.

There are multiple solutions that have been presented in prior art regarding interaction between social media users and development of trusted environment and review system. For instance, monitoring of negative feedback systems bearing U.S. Pat. No. 9,336,310B2 is issued to Google LLC. The patent is on a computer-implemented method for identifying on-line comments as being legitimate or illegitimate is disclosed. The method includes receiving a comment directed to a piece of on-line content, randomly determining whether to review the comment manually, and providing for review of information regarding the comment by a manual reviewer if a determination is made to manually review the comment. The chance of determining whether to review the comment manually is dependent on outcomes of prior manual reviews of received comments.

Another patent on Managing Reviews bearing U.S. Pat. No. 2,015,0161686A1 is issued to MINDSHARE TECHNOLOGIES Inc. The patent is on a technology is described for managing reviews of organizations. An example method of the technology may identify reviews of an organization sourced from an open review system, the open review system including reviews of unverified customers. Reviews of the organization may be collected from a closed review system which includes reviews of verified customers. The reviews from the closed review system may be reviews which are submitted by organization customers within a predefined period of time prior to a current time and the number of reviews used in the method may exceed a predetermined amount of reviews. The reviews may be converted from the closed review system into converted reviews formatted for the open review system.

Another patent on transitive trust network bearing U.S. Pat. No. 7,143,052B2 is issued to Accenture Global Services Ltd. The patent is on methods, data structures, and systems by which entities can efficiently discover, extend, validate and establish business relationships over a digital network are disclosed. A transitive trust system can be utilized by any number of interconnected entities in which at least two of the entities are capable of sharing information. One or more entity trust lists contain, for at least two of the entities, at least one characteristic. Each characteristic can, for example, describe or pertain to the actual or perceived dependability, reliability and/or credibility of an entity. The system also includes at least one transactional trust list that contains at least one parameter relative to an exchange between at least two of the entities through at least one degree of separation between the entities. The transactional trust list can, for example, be a listing of any type of parameters that define or describe business exchanges within a particular industry segment. The transactional trust list can also list information about the types of transactional activities that can take place and proxy actions available to cooperating entities. The system retrieves information from the entity trust list and the transactional trust list in order to provide a framework for at least two of the entities to establish relationships with one another.

A patent on system and method for secure three-party communications bearing U.S. Pat. No. 9,419,951B1 is issued to RPX Corp. The patent is on system and method for communicating information between a first party and a second party, comprising the steps of receiving, by an intermediary, an identifier of desired information and accounting information for a transaction involving the information from the first party, transmitting an identifier of the first party to the second party, and negotiating, by the intermediary, a comprehension function for obscuring at least a portion of the information communicated between the first party and the second party. The data transmission may be made secure with respect to the intermediary by providing an asymmetric key or direct key exchange for encryption of the communication between the first and second party. The data transmission may be made secure with respect to the second party by maintaining the information in encrypted format at the second party, with the decryption key held only by the intermediary, and transmitting a secure composite of the decryption key and a new encryption key to the second party for transcoding of the data record, and providing the new decryption key to the first party, so that the information transmitted to the first party can be comprehended by it.

A patent on Product review platform based on social connections bearing U.S. Pat. No. 1,000,7936B1 is issued to Valutrend Corp. The patent is on methods and systems are provided for managing product reviews for users based on their social data, wherein the social data may comprise data associated with or inferred from the users' social connections.

A System and method for detecting a dishonest user in an online rating system bearing U.S. Pat. No. 2,007,0265803A1 is issued to Deutsche Telekom AG. The patent is on system and method for detecting a dishonest rater participating in a rating system is provided. Raters enter ratings regarding al: least one entity which can be rated, and the ratings are stored. Individual values for the raters are calculated based on the ratings entered by the respective rater, and an indication value is determined based on the calculated individual values. The indication value is compared to a predetermined dishonesty threshold, and the rater is classified as dishonest based on the comparison result.

Another patent on System and method for content ranking and reviewer selection bearing U.S. Pat. No. 2,009,0119258A1 is issued to HELD REPORT Inc. The patent aims to provide systems and methods for content ranking and reviewer selection are disclosed. In one aspect of the present disclosure, a method of content review includes receiving submitted content and identifying reviewers based on a set of criteria. The submitted content can be presented to the reviewers and ratings of the submitted content can be received from the reviewers. In another aspect of the present disclosure, a method of rating reviewers includes providing content to a reviewer to be scored no the scale. The score provided by the reviewer user is recorded and the amount of time for the reviewer to score the content is tracked. Reviewer user rating can be adjusted based on the amount of review time.

A U.S. Pat. No. 7,603,350B1 on search result ranking based on trust is issued to Google LLC. The patent is on a search engine system provides search results that are ranked according to a measure of the trust associated with entities that have provided labels for the documents in the search results. A search engine receives a query and selects documents relevant to the query. The search engine also determines labels associated with selected documents, and the trust ranks of the entities that provided the labels. The trust ranks are used to determine trust factors for the respective documents. The trust factors are used to adjust information retrieval scores of the documents. The search results are then ranked based on the adjusted information retrieval scores.

Another patent on Ranking of users who report abuse bearing U.S. Pat. No. 8,856,165B1 is issued to Google LLC. The patent is on method, performed by one or more server devices, includes receiving an abuse report from a user, where the abuse report indicates that a comment associated with a document violates a policy associated with providing comments to users; retrieving a trust score of the user, where the trust score is based on a difference between a quantity of valid abuse reports previously generated by the user and a quantity of invalid abuse reports previously generated by the user; generating or adjusting a removal score of the comment based on the retrieved trust score of the user; comparing the removal score to a removal threshold; and removing the comment from further presentation to users if the removal score of the comment is greater than the removal threshold.

Generally, Today, online social networks have become the new meeting grounds. The development of such online social networks touch countless aspects of our everyday lives, providing instant access to people of similar mindsets, enabling us to create a trusted network and showing a trust relation between the service provider and the user, and enabling us to form relationships with more people in more ways than ever before.

There are multiple solutions that have been presented in prior art regarding the presentation of users' comments on services shared by a seller account. Within the last decade the advancement in likeness indicator has been seen. These incudes liking or disliking the service, use of emojis or gifs, leaving a comment, replying a message and much more. But looking at the prior art in a similar field, the improvement in effective utilization of technology and ease of use and expression building is greatly challenged. Most of these systems are made just to cover two extremes. However, this is not the scenario in real life environment. There is no such provision which has been found provides users a range of likeness, is trustworthy, and provides a consistent and unbiased reviews opportunity for the users.

The current invention proposes a system which works to ensure that people can build a trusted network and that network provides an ability where people can provide or receive services from seemingly unrelated. The system proposes creating a trusted network and showing a trust relation between the service provider and the user. The basic idea is if user A trusts user B and user B trusts user C. Then user A can trust user C.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

It is therefore the purpose of the invention to alleviate at least to some extent one or more of the aforementioned problems of the prior art and/or to provide the relevant public with a suitable alternative thereto having relative advantages.

The primary object of the invention is related to the provision of creating a trusted network and showing a trust relation between the service provider and the user.

It is further the objective of the invention to give a system w works to ensure that users can add another user to its trusted network.

It is also the objective of the invention to provide a system which is particularly developed for people where the system shall be able to find a trust path between two users if it exists.

It is moreover the objective of the invention to provide a system which works on multiple indicators including but not limited to true expression, reliability, and overall usability of the application.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 discloses the individual working as per preferred embodiments of the invention.

FIG. 2 discloses combined relationship among users as per preferred embodiments of the invention.

FIG. 3 discloses multiple relationships among users as per preferred embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The following description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but no other embodiments.

Reference in this specification to “social media” should be understood to refer to any type of electronically stored information that users send or make available to other users for the purpose of interacting with other users in a social context. Such media can include directed messages, status messages, broadcast messages, audio files, image files and video files. Reference in this specification to “social media websites” should be understood to refer to any website that facilitates the exchange of social media between users. Examples of such websites include social networking websites such as Facebook and LinkedIn and microblogging websites such as Twitter.

The current invention in its preferred embodiment discloses a next generation of Social network facilitation approach where a simple one way or two-way relation is facilitated, and user adds a second user as a person or entity whom this user trust/knows/have worked with before.

Websites that allow users to interact with one another have exploded in popularity in the last few years. Social networking websites sites such as Facebook and LinkedIn, and microblogging websites such as Twitter enjoy widespread use. Millions of users post messages, images and videos on such websites on a daily, even hourly basis, oftentimes reporting events on a real-time or near-time basis and revealing the user's activities and interests. Users typically direct messages to specific persons, their social group, or perhaps businesses maintaining a presence on social networking websites; however, oftentimes such messages are visible to the general public. The Facebook, Instagram and twitter of the world have adopted the “Add Friend” button but that's not enough for people to know that they can add the person or not. The present invention believes people are complex users who can't trust to add anyone in their network. The trust, word of mouth and likeness indicator is required to add another user in personal network.

As per exemplary embodiments of the invention, the working of a system where a user can be of two types. One is a person who is seeking a service from a service provider and the second person is a service provider who will be providing services to a person seeking a service.

The trust relation or trust can be created where a simple one way or two-way relation when one user adds a second user as a person or entity whom this user trust/knows/have worked with before. The set of trust relations that will span from one user to another. For instance, a Trust path between User1 and User6 will be User1-->User2-->User5--->User6.

The Root user is a user seeking a service. Example: For the path User1-->User2-->User5--->User6; User1 is a root user. The End user is a service provider. Example: For the path User1-->User2-->User5--->User6 and User6 will be an end user

The Downstream user is a user next in chain from the root user. Example: For the path User1-->User2-->User5--->User6. The User2-->User5--->User6 will be downstream users.

The Upstream user is a user before in chain from the end user. Example: For the path User1-->User2-->User5--->User6 User1-->User2-->User5- will be upstream users.

Furthermore, there is a possibility that there will not exist a trust path between the two users. There is also a possibility that more than one path exists between the two users.

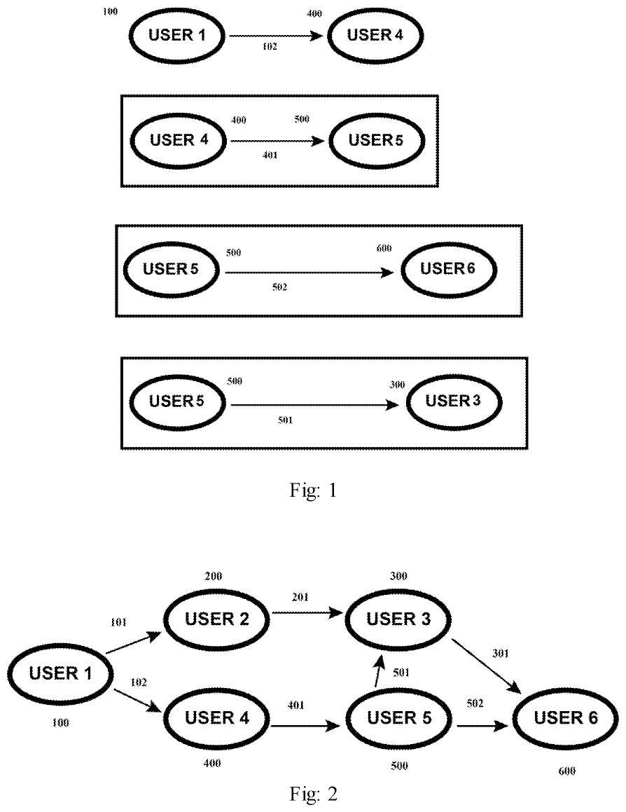

The attached drawings are showing the relationship map and method of enabling trust among multiple users. FIG. 1 represents the users where User 1 is represented by 100, User 2 is represented by 200, User 3 by 30 and so on. The users are individual entities which are connected via trust relation. The FIG. 1 depicts this trust relation with 101 and the relationship is formed between User 1 (100) and User 2 (200). Furthermore, the relationship of trust among User 2 (200) and User 3 (300) is shown with relationship 201 and trust relationship 301 shows relation between User3 (300) and User 6 (600).

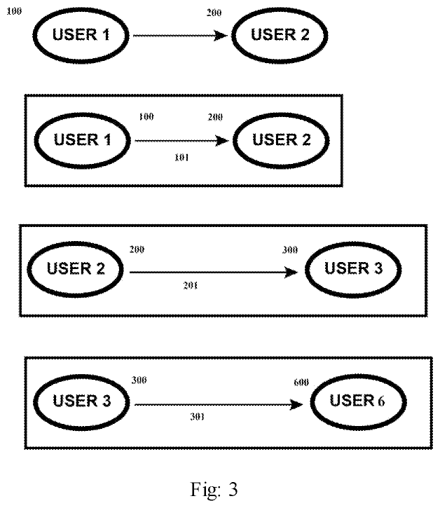

The FIG. 2 represents relationship among two types of users. The User 1 (100) is connected with User 4 (400) with relationship 102. Furthermore, the User 4 (400) is connected with User 5 (500) with relationship 401. The user 5 (500) is connected with User 6 (600) is connected via 502 relationship. Furthermore User 5 (500) is connected to User 3 (300) via 501.

The FIG. 3 represents connection of all users among the trust chain relationship. The User 1 (100) can be connected to User 2 (200) and User 4 (400) through relationship 101 and 102. The User 2 (200) and User 3 (300) are connected with relationship 201 and User 4 (400) and User 5 (500) are connected with relationship 401. The User 5 (500) and User 6 (600) are interconnected with relationship 502. The User 6 (600) can also be connected to user 3 (300) with relationship 301. Furthermore, the User 5(500) can also be connected with User 3 (300) with relationship 501.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

1. A method for providing trust between users in an ecommerce transaction, the method comprising:
as in claim 1 wherein the secure execution space comprises a protected processing environment;
as in claim 1 wherein the secure execution space comprises a hardware based secure processing unit;
as in claim 1 wherein the system provides a rights operating system, and the service function executes as an application of the rights operating system.
as in claim 1 wherein the system incorporates building of trust tables for the plurality of the users;
as in claim 1 wherein the system finds trusted path between the users;
as in claim 1 wherein the system uses trusted path to enable peer to peer communication;
as in claim 1 wherein the system uses trusted path to enable peer to peer transaction.

2. The method according to claim 1, further comprising:
Building an individual trust table for all users by adding plurality of users known to the user.
Plurality of peers adds other plurality of peers to the trust table by virtue of knowing or working with the peers previously.

3. The method according to claim 1, further comprising:
Construct trusted paths by looking into the first users trusted table, further looking into the trust table of all the users in the first users trust table, until the second user is found.

4. The method of claim 1, wherein the trusted path is displayed to the user before the start of the transaction.

5. The method of claim 1, wherein the trusted path is used by the system to select the best user.

6. The method of claim 2, wherein the weights are added to the user trust table.

7. The method of claim 3, wherein the trusted path dynamically generated.

8. The method of claim 3, wherein the trusted path is pre computed and cached.

9. The method of claim 3, wherein the single best trusted path can be generated.

10. The method of claim 3, wherein multiple trusted paths can be generated.

11. The method of claim 4, wherein the display method will be any electronic device.
